(19) United States
(12) Patent Application Publication
(10) Pub. No.: US 2005/0278296 A1
(43) Pub. Date: Dec. 15, 2005

(54) Method and system for creating, sustaining and using a transactional bill of materials (T-BOM ™)

(76) Inventor: Peter Bostwick, Menlo Park, CA (US)

Correspondence Address: Deborah Neville, PO BOX 61063, Palo Alto, CA, 94306, US

(21) Appl. No.: 11/144,528

(22) Filed: Jun. 2, 2005

Related U.S. Application Data
(60) Provisional application No. 60/578,152, filed on Jun. 8, 2004.

(51) Int. Cl. G06F 7/00

(52) U.S. Cl. 707/1

(57) ABSTRACT

The inventive approach provides a dynamic data system and computationally efficient method to uniquely identify a product of interest and by means of querying any number of databases for pertinent transaction data, create a complete product history (lifecycle) as well as the current product state. The inventive method provides a means for rapidly assigning a unique identifier to specific instances of a product or component. The invention also provides for the elimination of duplicative or obsolete lifecycle data, generating a current picture of product data (denominated, by reason of the method of creation, a “transactional bill of materials” (T-BOM™) for every product component or composite product. The invention provides a method supportive of improved product uptime as well as other advantages including improved customer service, reduced costs to provide customer service, and profitability management.

### RELATED APPLICATIONS

This Application is related to Provisional Application No. 60/578,152, filed Jun. 8, 2004, the entirety of which is incorporated by reference as if fully set forth herein, and priority is claimed from Jun. 8, 2004.

### GOVERNMENT FUNDING

Not applicable.

### BACKGROUND

1. Field of Use

The invention relates to data acquisition, organization and utilization, particularly data relating to transactions germane to items in the stream of commerce.

2. Background

Tracking and tracing sources of materials has long been standard in health and safety concerned industries, such as the food and pharmaceutical industries and in industries impacted by gray market and counterfeit such as high-technologies industries. Quality control and human safety depends on the ability to identify lots or batches. Accounting systems have used “track and trace” and “where used” and other tools primarily on a basis not adapted to the specific composition on any uniquely identifiable product unit. Current systems operate by maintaining a master equipment record or serial record that is updated.

To operate successfully, organizations need to understand the what, where, who, and how of their products: what the product looks like now and at any particular time in the past; where the product is now and where it has been at any particular time in the past and for how long; how the product was built (i.e. identification of the product's components); who built their products, including who built the components incorporated into the products, who shipped the products, who signed off on them, who serviced them.

A current approach is to use a static “bill of materials” (BOM) and equipment masters. Such an approach keeps track of the product, but relies on updates to a master record. Such master databases are vulnerable to losing data if it arrives out of strict chronological order. What is needed is a dynamic data assemblage system that incorporates all pertinent data and is unsusceptible to such data loss.

Alternatively, some systems have the capability of running a “where-used” report. A where-used report is generated by looking through a set of transactional information to compile information about the history of a product. Where-used is typically used in the process manufacturing industries. There is a need to apply the compilation of transactional records to all industries—especially those for discreet manufacturing. Moreover, current ERP systems treat batch tracking (ex. a “batch” of acetylsalicylic acid (aspirin)) and item tracking (ex. a specific bottle of aspirin) as completely different processes. What is needed is a means for seamlessly tracing of constituents through the stream of commerce.

Moreover, there are severe limitations to current approaches because they cannot model a complex product as it changes over time. Where-used is not able to “net out” historical transactions and then reconstruct the product composition at any specified past date. Further, most “track and trace” is accomplished by compiling data from paper records when an emergency exists. For the most part, track and trace has not been a part of daily operations.

What is needed is a system that will facilitate tracking and tracing products and components as an ongoing process in businesses, such as the ongoing processes of shipping or receiving. In these and other business processes, integration and automation of specific product data are essential to enabling valuable and detailed analysis.

Currently, the transactional data needed for more detailed track and trace is gathered neither within companies nor within supply chains. Track and trace is most typically done on a lot basis, especially in the high volume industries. Current methods of lot number assignment are not computationally efficient and do not enable the desired level of detailed analysis.

What is needed is a computationally efficient approach capable of producing a detailed record of all serial numbers within a product using bill of material structure. What is further needed is a means of quickly and accurately identifying a current state of a product, reflecting the result of the changes to components of the product during its product lifetime to date.

### SUMMARY OF THE INVENTION

The inventive approach provides a dynamic data system and computationally efficient method to track and trace every uniquely identifiable item in a product throughout the product history as well as the current product state. The inventive method provides for the rapid utilization of unique Serial Numbers, allowing for a “transactional bill of materials” (T-BOM™) for each product, and in some instances the product's components. The invention provides a method supportive of improved product uptime as well as other advantages including improved customer service, reduced costs to provide customer service, and profitability management, to name a few.

The inventive System and method, an output of which is referred to herein as T-BOM™, provides installed base service and pedigree generation as well as installed base profitability determination. The invention provides for the dynamic creation of a T-BOM™ based on the relevant set of historical transactions. Stated in the simplest of terms, the inventive method exploits any unique number attributed to parts and products (ex. serial numbers, lot numbers, batch numbers, etc.). Each part in the bill of materials is identified by a part number (and perhaps revision number) and each instance of that part is uniquely identified by a serial number or other identifier (lot number, control number, EPC number, etc.).

The initial T-BOM™ structure may be defined from an initial set of relevant transactions. This initial set of transactions could be the transactional records for a sales order, a production order, purchase orders or any transaction that changes the location, state, components or parents of a product. Once the initial structure has been thusly defined, subsequent transactions are likewise amenable to the structure. Any database query concerning a product can then generate a corresponding T-BOM™ which will accurately reflect the product state at any date, present or past.

The inventive method uses dynamic transactional data retrieved and organized in response to a query to one or more databases. Significantly, in the strictest sense, owing to the fact no master database is required and often portions of relevant transactional data resides in disparate databases altogether, the T-BOM™ does not exist until a request is executed. Prior to execution of a request to build (a query) a T-BOM™ is inchoate. The inventive approach uses the actual transactions of building, shipping, repairing, retiring, etc. to understand what has happened to any serialized product of interest. By capturing, organizing, and analyzing those transactional records it is possible to infer what has happened to a product and build up the product history and current product state. Moreover, the inventive system and method provide for using any selectable identifier to link to other transactions of interest that are related, but not necessarily at the product level.

The inventive method provides data capture and data validation technology. The integrity and timeliness of data is critical. Auto-id technologies such as bar-code labels and scanners, RFID tags and readers, and wireless and wired networks are all enabling technologies. These technologies enable the rapid, accurate and in some cases, automatic collection of transactional information.

The invention provides a means for acquiring complete historical data (Lifecycle) concerning a uniquely identifiable product of interest in the stream of commerce. The invention also provides a T-BOM™: the current snapshot of product composition, that is to say, the product Lifecycle with extraneous historical data eliminated. The T-BOM™ is enabled through a “Unit-Set”—a database object that represents every relevant transaction, and hence the associated transaction data, for any given uniquely identifiable product. A relevant transaction is one that changes the location, characteristics, state, or components of the product in question. The tabularization of the Unit-Set optimally denormalizes the data, and permits the use of the transaction details to generate the T-BOM™.

Another aspect of the preferred embodiment is tabularization of the data. The table form is essentially an hierarchically organized set of transactions, whose organization facilitates the T-BOM™ creation. The table itself is derived from data fields, where data fields may include: serial number or any appropriate unique product identifier, BOM flag, Pointers (fields linking the Unit-Set records with corresponding transaction records in any of multiple databases/systems), Position (level information in product composition) and calendar date.

Another aspect of the preferred embodiment is the imposition of hierarchy on product data. The hierarchy is structured with headers (e.g. product class: bicycle) and items (e.g. component class: wheel, spoke, hub). The hierarchy underlying the tabularization and the method employed to obtain responses to data requests provide a means to rapidly obtain current data regarding any product of interest.

To dynamically generate a T-BOM™ the inventive method includes the steps of:
1. Running a query based on Serial Number (SN);
2. Selecting all Unit-Set records with SN equal to SN in Step 1;
3. Selecting all Unit-Set records with Pointers equal to Pointers in Step 2;
4. Repeating Steps 2 and 3 until top and bottom of BOM are reached;
5. a. Sorting, grouping and arranging selected Unit-Set records;
   b. Producing (from 5a) Product history (Lifecycle) for queried SN;
   c. Embellishing Unit-Set records by selecting data by means of Pointers
6. a. Eliminating duplicate and obsolete Unit-Set records;
   b. Producing (from 6a) T-BOM™ for queried SN;
   c. Embellishing Unit-Set records by selecting data by means of Pointers.
      Where “Header” level data is “parent”, and “Item” level data is “child”. the preferred embodiment of the method comprises the steps of:
1. Running a query based on Serial Number (SN) and target date/time;
2. Selecting all Unit-Set records for the SN in Step 1;
3. Selecting all Unit-Set records for children of the queried SN and children of the children records;
4. Selecting all Unit-Set records for the parents of the queried SN and the parents of the parent records;
5.
   a. sorting and grouping the selected Unit-Set records;
   b. producing (from 4a) product lifecycle history for queried SN;
   c. embellishing Unit-Set records by selecting data by means of Pointers;
6.
   a. eliminating duplicate and obsolete Unit-Set records;
   b. producing (from 5a) T-BOM for queried SN;
   c. embellishing Unit-Set records by selecting data by means of Pointers.

Additional aspects of the inventive method include the use of agents and Serial Number generation. Further embodiments are set forth in the Detailed Description herein, inclusive of the Tables.

Further provided is an inventive search method enabled by the inventive System and method. Because the T-BOM™ enables 360 degree visibility of products, the T-BOM™ enables powerful and comprehensive product data search. By entering the product, order number, or serial number, the full product lifecycle and current configuration can be viewed. This application of the invention is useful to, for example, isolate defective equipment, determine the location of components within larger pieces of equipment, and for locating units or cartons within larger containers.

Another aspect of the invention is in the application of software patch and release management. Because software patches and releases contain modules of code that are changing, one can use the T-BOM™ to understand how programs and systems looked at any given time. By applying a unique identifier to modules or sections or objects of code one can track and trace the changes to the system over time. A user can also understand what is in a given patch and with additional input can determine what areas of the system are impacted by each release or patch. This additional input can take the form of business requirements, user interface points, steps in a documented business process, etc.

Any computer readable instantiation of the inventive System, or method, or any portion thereof, or application of the System, method or any portion thereof, is included within the scope of the invention.

### BRIEF DESCRIPTION OF THE DRAWINGS

FIG. 1 is a diagrammatical representation of the Steps to create a T-BOM™ according to the preferred embodiment.

FIG. 2 is a screen shot showing search results using the inventive T-BOM™.

### DETAILED DESCRIPTION OF THE INVENTION

Introductory remarks. The inventor has coined certain language to describe aspects of the inventive system and method. Specifically, this application refers to Transactional Bill of Material™, Transactional BOM™, and T-BOM™, each term is intended to be synonymous with the other and any may be used interchangeably without change in meaning. (The phrase “bill of material” or “BOM” has a generally accepted meaning, and applicant intends the generally understood meaning.)

“Serial Number” (SN) means a unique identifier of a product instance. Serial Number should also be understood to include any of a variety of selectable identifiers, alone or in combination, where such identifiers include serial number, unit number, lot number, product number, equipment number, batch number, revision number, control number, EPC code, customer number, order number, calendar date, and any other identifier that can be used to uniquely identify or link to transactions of interest. “Serial Number” includes any later devised means of uniquely identifying a product of interest. “Unit-Set” as used herein refer to a database object that represents every relevant transaction, and hence the transaction data, of every Serial Number. “Pointer” as used herein means a database field that allows the Unit-Set to be lined with the corresponding transaction records. The corresponding transaction records may be in different databases, companies, computer systems, locations or database structures. A Pointer may be at any level of the hierarchy (ex. header or item). The term “component”, as in “product component”, may be understood to be included when the terms “header”, “item”, or “children” are used.

References to the “System” mean the inventive method and system as implemented on computational devices and databases and data transmissive devices as may be operable in communication taught herein, inclusive of the tables, drawings and claims. Additional terminology is set forth hereinbelow; terms familiar in the field of data management generally are intended to have the generally understood meaning.

General Comments. Significant computational efficiency is generated as a function of the manner in which the preferred embodiment of inventive system intakes, processes and generates data and information. All transaction data will come into the System and will have at most one header record and one or more item level records. The header level must be of a quantity of one, because a 1:1 or at most a 1:M relationship between header and item or item and item relationships must be maintained.

Examples of Header—Item relationships include:
Header: (ex. bike) and Item (ex. components—tires, frame)
Header: (ex. installed base item) and Item (ex. components)

Examples of Item—Item relationships include:
Item: Original part and Item: Replaced part

The basic structure of data coming into and stored according to the System is hierarchical:

Header Level

Item level
   The 1:1 and 1:M relationship and the requirement is applicable for discrete products. The T-BOM™ approach is equally applicable for continuous or process product tracking as well. For applications such as these, the lot or batch number of the product is used.

The System receives data from multiple sources. Data may be input from RFID, from another system (for example, service management) or even original data from a manufacturing database. One inventive aspect of the System is the concept of a Unit-Set. The Unit-Set is a database object that represents every transaction, and hence transaction data. of every Serial Number. The preferred embodiment uses a table format to achieve optimal denormalization of the data thereby increasing speed of the system. Despite the space occupied by redundant data contained in the table format, the inventive System provides heightened performance more than compensating for any cost associated with the space usage. In a sense, the invention is just “redundant enough” to optimize performance.

The Unit-Set fields and the description of such fields used in the preferred embodiment of the System appear in Table 1.

TABLE 1
UNIT-Set

| Field | Description |
|---|---|
| Serial number | (see paragraph 28 hereinabove) |
| | SN = any identifier that is specific to a |
| | physical unit. Serial number is used |
| | interchangeably with unit number, lot |
| | number, equipment number, batch |
| | number, revision number, control |
| | number, EPC code and any other |
| | identifier that can be used to uniquely |
| | identify products with the same product |
| | level identifiers |
| | If a single identifier is not unique, it can |
| | be combined with another number |
| | (ex. a product number). |
| Product number | Code identifying the product. The |
| | serial number and product number |
| | must uniquely identify a specific |
| | instance of a product. If more |
| | information is required for unique |
| | identification, such as the originating |
| | system, the company code, the |
| | location, etc., those fields are required |
| | as well and will be added where ever |
| | the requirement for serial number and |
| | product is noted herein. |
| | If the serial number is unique, product |
| | number is not required. |
| BOM flag | This is used to determine if the Unit-Set |
| | record has an impact on the BOM. |
| | Multiple values are possible. Examples |
| | include: |
| | Add - additive to the BOM structure |
| | (examples include production order |
| | receipts/issues, service replacement) |
| | Remove - taking a part away from the |
| | existing product structure. (examples |
| | include discarded or replaced parts) |
| | BOM flag can actually be much more |
| | than this. Depending on the goal, |
| | pulling in different records may be |
| | desirable. Examples include Use the |
| | flag to indicate the original base |
| | production order; use the flag to |
| | indicate when a product is released to |
| | the market place (for gray market or |
| | pedigree) |
| Pointer(s) | These are fields that allow the Unit-Set |
| | to be linked with the corresponding |
| | transactional records. This can be |
| | done at both the header and the item |
| | level. Pointers can point to different |
| | companies, computer systems, |
| | locations, or in different data |
| | organizations. |
| | These fields are—in part—the system |
| | order numbers representing the |
| | transactions. |
| | Pointers also point to different |
| | attributes or characteristics of the |
| | transaction. These can include |
| | location, status, state, etc. |
| Position | Used to tell if the unit-set record is part |
| | of the transaction header or item level. |
| Date | Calendar date & time of transaction. |

As an aid to understanding the invention, a tangible example is now considered: a bicycle as it is composed of a subset of components (ex. Frame and wheels [hubs and spokes]).Table 2 below illustrates an example hierarchicalized data associated with a number of transactions incurred to build and service a bicycle. The first column identifies the level of information. The second column describes the field name: SN, serial number, is unit data. The four columns to the right illustrate transactions on various dates with the last transaction on 9/04.

TABLE 2

| | | Production | Production | Service order | Service order |
|---|---|---|---|---|---|
| Level | | order 1 | order 2 | 1 | 2 |
| Header | Order ID | PR100 | PR200 | SM100 | SM200 |
| | Product | Bike | Wheel | Bike | |
| | Date | 07/03 | 06/03 | 08/04 | 9/04 |
| | Location | Dallas | Tokyo | Chicago | Chicago |
| | Quantity | 1 | 1 | 1 | |
| | SN | 111 | ABC | 111 | |
| Item 1 | Product | Wheel | Spokes | Wheel | Spoke |
| | Direction | Add | Add | Remove | Remove |
| | Quantity | 2 | 3 | 1 | 1 |
| | SN | ABC | JKL | DEF | JKL |
| | SN | DEF | MNO | | |
| | SN | | PQR | | |
| Item 2 | Product | Frame | Hub | Wheel | Spoke |
| | Direction | Add | Add | Add | Add |
| | Quantity | 1 | 1 | 1 | 1 |
| | SN | GHI | STU | YYY | RRR |

The corresponding Unit-Set from these transactional records is described in Table 3.

TABLE 3

| | Serial | Product | | | |
|---|---|---|---|---|---|
| Pointer | Number | Number | Position | BOM flag | Date |
| PR100 | 111 | Bike | H | | Jul-03 |
| PR100 | ABC | Wheel | L | + | Jul-03 |
| PR100 | DBF | Wheel | L | + | Jul-03 |
| PR100 | GHI | Frame | L | + | Jul-03 |
| PR200 | ABC | Wheel | H | | Jun-03 |
| PR200 | JKL | Spoke | L | + | Jun-03 |
| PR200 | MNO | Spoke | L | + | Jun-03 |
| PR200 | PQR | Spoke | L | + | Jun-03 |
| PR200 | STU | Hub | L | + | Jun-03 |
| SM100 | 111 | Bike | H | | Aug-03 |
| SM100 | DEF | Wheel | L | − | Aug-03 |
| SM100 | YYY | Wheel | L | + | Aug-03 |
| SM200 | JKL | Spoke | L | − | Sep-03 |
| SM200 | RRR | Spoke | L | + | Sep-03 |

According to the data, the resulting transactional bill of material, T-BOM™ for the bicycle in this example on or after 9/04 is summarized in Table 4.

TABLE 4

| Product | Serial Number |
|---|---|
| Bike | 111 |
| Wheel | ABC |
| Hub | STU |
| Spoke | RRR |
| Spoke | MNO |
| Spoke | PQR |
| Wheel - YYY | YYY |
| Frame - GHI | GHI |

This simple bicycle example illustrates the principle that any set of transactions in hierarchical form permits the creation of a T-BOM™. It is useful here to understand the notion of the “parent” or “child” of any product of interest. In the bicycle example, a “header” is a “parent” and any “item” is a child. Thus, for Serial Number 111 (see Table 4) the “children” are ABC, DEF, and GHI. Bicycle SN 111 has no “parents”. If one enters “wheel” as the product of interest, then “Spokes” are “children” and “bicycle” is a “parent”. For the purposes of this application and the language used to express these relationships, the product of interest may have offspring (children) or the product of interest may itself be the offspring to a parent. Moreover, BOM depth is the number of iterations needed to pass through the Unit-Set table to reach the end point of the BOM. If, for example, the BOM has five parent-child relationships, the BOM depth is five.

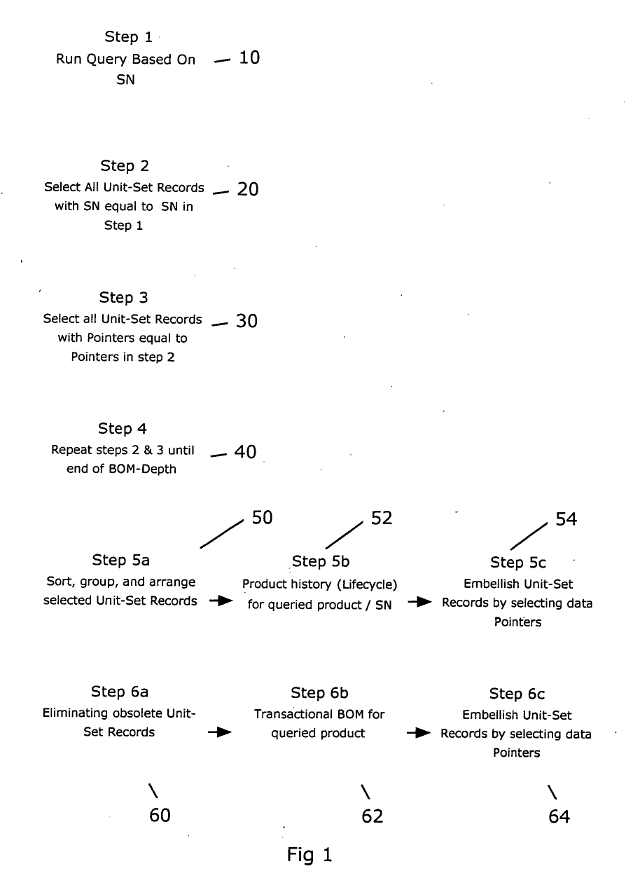

Generating a T-BOM™. The preferred embodiment of generating a T-BOM™, and the method employed by a System as taught herein, is illustrated in FIG. 1. Terms used are introduced in the preceding section and further elaborated in the accompanying tables. The concepts of general data input, querying databases, structuring data in hierarchical form, and the skills appurtenant thereto are generally assumed to be familiar and are not set forth in detail here. Referring to FIG. 1, the inventive method includes the steps of:
10 STEP 1 Running a query based on Serial Number (SN);
20 STEP 2 Selecting all Unit-Set records with SN equal to SN in Step 1;
30 STEP 3 Selecting all Unit-Set records with Pointers equal to Pointers in Step 2;
40 STEP 4 Repeating Steps 2 and 3 until the top and bottom of the BOM is reached;
50 STEP 5 a. Sorting, grouping and arranging selected Unit-Set records resulting in 5b;
52 STEP 5 b. Producing Product history (Lifecycle) for queried SN;
54 STEP 5 c. Embellishing Unit-Set records by selecting data by means of pointers;
60 STEP 6. a. Eliminating duplicate and obsolete Unit-Set records resulting in 6b;
62 STEP 6 b. Producing Transactional Bill of Material (T-BOM™) for queried SN;
64 STEP 6 c. Embellishing Unit—Set records by selecting data by means of Pointers.
   Where “Header” level data is “parent”, and “Item” level data is “child”, an alternate embodiment of the method comprises the steps of:
   Step 1 Running a query based on Serial Number (SN) and target date/time;
   Step 2 Selecting all Unit-Set records for the SN queried in Step 1;
   Step 3 Selecting all Unit-Set records for children of the queried SN and children of the children records;
   Step 4 Selecting all Unit-Set records for the parents of the queried SN and the parents of the parent records;
   Step 5
      a. sorting and grouping the selected unit-set records;
      b producing (from 5a) product lifecycle history for queried SN;
      c embellishing unit-set records by selecting data by means of Pointers;
   Step 6
      a. eliminating duplicate and obsolete unit-set records;
      b. producing (from 6a) T-BOM™ for queried SN;
      c. embellishing Unit-Set records by selecting data by means of Pointers.

Referring again to FIG. 1, at the completion of Step 5a 50, the resulting array represents the entire product lifecycle, that is to say, the complete history of the product. After Step 6c 64 through subtracting out duplicate and obsolete records that do not reflect the composition of the product at the time of the data inquiry, the T-BOM™—the current composition of the product—is created. Steps 5b and 6b effectively enrich the Unit-Set and permit data collection sufficient to satisfy a selection criteria. For the bicycle example described above, if the query posed was “show me the status of bike whose serial number is 111 as of 9/04”, the T-BOM™ and Pointers provide the data necessary to accomplish the task at hand (e.g. the composition—wheels, hub, spokes, and frame—of bike serial number 111 on 9/04).

The method as depicted in FIG. 1 illustrates going “down” the T-BOM™ structure, and it is intended that the invention include any bidirectional application of the method (going “up” as well as “down”).

Another aspect of the invention (not illustrated) also includes a method and process for collecting information both proactively and through passive means that will become the data comprising the transactional information and the Unit-Set.

Such information collection consists of two approaches. One approach in the present preferred embodiment is the use of intelligent agents that exist in external systems that monitor for transactions, then packetize the relevant data and send it through a set of business rules and data processing tools to populate the relevant database. Another approach is the ability to accept packets of information from as of yet unknown data sources. The packet of information will contain sufficient information (based on published standards) to allow the inventive system to send the data through a set of business rules and data processing tools to populate the relevant database.

Serial Number Generation. In order to uniquely identify an instance of a product, it is assigned a Serial Number (SN). The number may be the serial number or it may supplement the serial number in further identifying the product in time and space. The generated number, referred to herein as “Serial Number” or SN, can then be assigned to a product (physically or virtually).

The method and system for generating a unique and informationally intelligent Serial Number is included in this invention. The system takes into consideration information like the calendar date, the order number and order type, the locations, the last transaction, the parties (people, partners) involved, etc. This information is determined through a set of business rules that can be specified by the type of product the transaction being performed and any number of additional parameters including but not limited to: Date. Location, and Parties Involved.

Analytics. Table 6 provides a partial listing of analytical tools that are aspects of the inventive system. These are made possible and can be computationally derived in a fast and accurate fashion through the use of the product lifecycle and T-BOM™ described herein. These tools are built around a common framework, with the idea that a number of different ways may be used to get to the right object(s) (serial number, order number, partner, product) and use that object to get more information.

The current embodiment employs a “wizard” approach: the user is asked questions a screen at a time; when the user has narrowed down the information to the point desired, the user can choose from a set of options to express that information. The basic format is:
What do you want to do?
What do you know?
What do you want to do?

The process is iterative. Table 6 contains features of the preferred embodiment of the invention.

TABLE 6

| Analytical Tool | Description |
|---|---|
| Drill up the | With a chosen set of objects, show the previous |
| supply chain | objects. Only one level if we don't have serial |
| | number. Example: if we chose an order, show |
| | the products that went into that order. If we |
| | have serial number we will show 3 levels. |
| Drill down the | Same as drill up, but in the other direction. |
| supply chain | |
| Recall wizard | A screen, tables, and a process for monitoring |
| | and executing and documenting a recall. |
| | This is a highly sophisticated tool that formalizes |
| | and documents the entire recall procedure. The |
| | results are that you can “Certefi your Recall”. |
| | Once a set of products are identified through the |
| | “what do you know?” phase, these are |
| | populated into a recall table. These records are |
| | identified by a recall number. |
| | Additional units can be added to the recall, but |
| | they can never be removed. |
| | More than one lot can be included in a given |
| | recall. The entire list of lots is shown on the top |
| | right side of the screen. The selected lot is |
| | detailed on the left side of the top and in the |
| | body of the screen. On the bottom right of the |
| | summary section, the entire recall summary is |
| | displayed. |
| | The records in the database are populated at |
| | the time of the recall creation. On request, they |
| | can be updated (or if the update is not desired, |
| | rolled back to the original creation record). |
| | One may also enter this screen simply by |
| | choosing an existing recall number. |
| | For a given set of records, the last location is |
| | shown. The user then updates the screen (and |
| | therefore database) with the information about |
| | each location of products. The status can be |
| | moved from any value to any other. Each |
| | change in the record is recorded. A special log |
| | is made for each status change requiring a |
| | change to the notes as well. |
| | Additional information shown includes: the |
| | partner that currently has the product (if |
| | applicable). The order number involved with the |
| | last know transaction. This could be a shipment |
| | to a customer, or a transport order, etc. The |
| | order is hot linked. We should be able to click |
| | on this and show the order in another system. |
| | The quantity at the specific location is shown as |
| | well. Underneath the quantity is a “Split” hot |
| | link. By pressing on this link another screen |
| | pops up and allows you to split the quantity into |
| | one or more additional lines. This is in the event |
| | that something beyond what is captured in |
| | Certefi has happened to the product. |
| | The user will be able to enter comments in the |
| | notes section. This is a text editor with cut, |
| | copy, and paste capabilities. We want the ability |
| | to integrate outlook or other mail application to |
| | the notes. Ideally we will be able to generate e- |
| | mails from the notes page. These e-mails will |
| | then be associated with this record for auditing |
| | purposes. |
| | As the status is changed for each line, the status |
| | summary is updated to reflect the changes. |
| | Statuses are configurable. |
| | A set of reports are available as downloads. |
| | The first report is at the lot level. For the |
| | selected lot, the summary and summarized |
| | details are listed. For the recall report, all of the |
| | lots in the recall are listed again with |
| | summarized details. |
| Commonality | One can choose a set of objects and have the |
| analyzer | system come back with an analysis of what all or |
| | most of them have in common. This requires |
| | the use of fuzzy logic. We see a set of |
| | responses with probabilities associated with the |
| | analysis. Examples include: these products |
| | shipped in the same container (65%); these |
| | products have a coating of product A batch JJJ |
| | (100%); these products contain components |
| | purchased from the same vendor (90%); |
| Pedigree | This is a special drill up the supply chain report. |
| Generator | The master data shown is specific (product |
| | name, dosage, container size, # of containers) |
| | In the detail section, each step along the supply |
| | chain from the shipment from the original |
| | manufacturer We need to see the lot or control |
| | number. Specific information for each step must |
| | include: business name and address, date. We |
| | also want to include order number, user, and |
| | source. |
| Gray market | Used internally. Enter at least the product and |
| tester | serial number. It will come back with the last |
| | known location. It will also come back if there is |
| | a duplicate in serial numbers or if this serial |
| | number does not exist at all or if this serial |
| | number does not match the defined format, etc. |
| Product | Used externally. Asks the user for: |
| integrity | Product, serial number, location information. |
| validator | Based on user input, it will come back with |
| | “okay” or a request for more information and a |
| | potential warning message and way to contact |
| | the original manufacturer or the appropriate |
| | authorities. |
| Fraud | A user has the ability to select a product or serial |
| detection | number and find out if there are any suspicious |
| wizard | activities. For example: how many returns |
| | against this product, consistency of serial |
| | numbers, etc. |
| Upgrade/ | When it is time to upgrade or conduct service for |
| service | a set of products, the wizard gives you the |
| targeter | information needed to understand more about |
| | the installed base and give you the necessary |
| | information to contact he owner of the product. |
| | Potential integration back to a CRM system or |
| | integrate with word for a form letter or outlook for |
| | a form e-mail. |
| | Similar to the recall wizard we want to keep |
| | track of who we sent what to and whether we |
| | received any response. |
| Find serial/ | Simply gives the serial numbers for the selected |
| lot/batch/ | product. |
| unit | |
| numbers | |
| Installed | A report that shows the composition, |
| base | configuration and location of an installed based. |
| | Either by a single serialized product or for a |
| | group of products. The report can show all of the |
| | serialized components (including software and |
| | configuration options). |
| Profitability | This is a special case of the installed base |
| analyzer | because in addition to showing the current |
| | configuration of the product, it includes a |
| | historical account plus a line by line cost and |
| | revenue accounting of all transactions. |
| | The report can also be supplemented with |
| | allocated costs. |

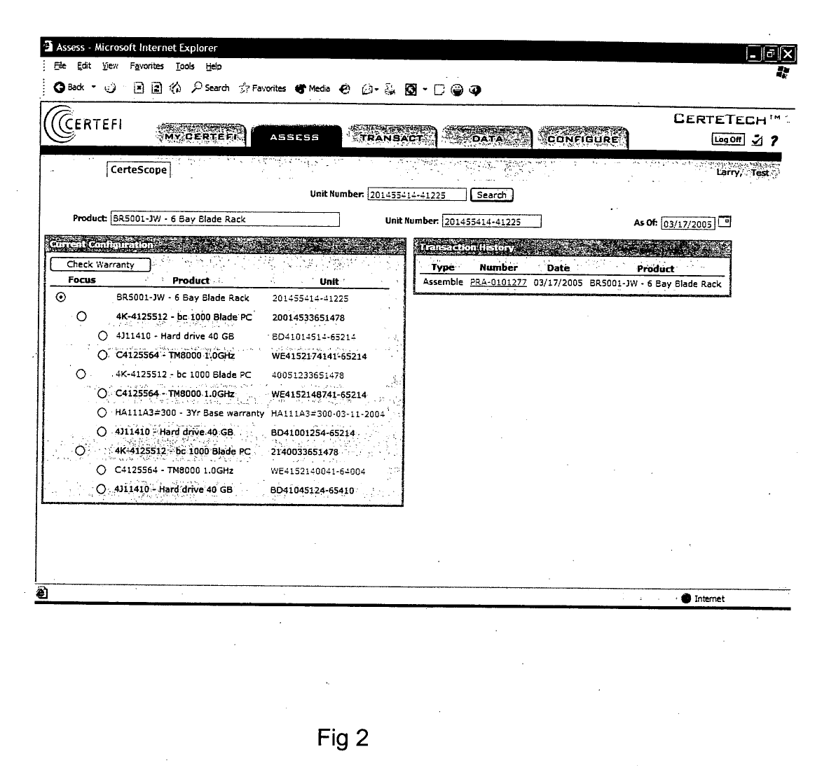

Using the T-BOM™ for product search. Because the T-BOM™ gives a 360 degree visibility of the product of interest, the System also provides a powerful product search tool. By entering the product, order number, or serial number, the user is able to see the full product lifecycle and current/historical configuration. Such an application of the invention can be used to isolate defective equipment, determine the location of components within larger pieces of equipment, and for locating units or cartons within larger containers. FIG. 2 is a screen shot of the CerteScope™ product search feature according to the current embodiment.

Application to software patches/release tracking. Another aspect of the invention is in the application of software patch and release management. Because software patches and releases modules of code that are constantly changing, one can use the T-BOM™ to understand how things looked at any given time. A user can also understand what is in a given patch and with additional input can determine what areas of the system are impacted by each release or patch.

The invention has a plethora of commercial applications. It may be used in installed base management for practically any industry. Examples include large medical equipment (MRI, etc); semiconductor manufacturing equipment; manufacturing plant maintenance; automotive and aircraft engine maintenance. Further, it may be applied to military equipment preparedness including maintenance of aircraft, tanks and other equipment. The invention has usefulness in lifecycle reporting, pedigree generation, recall and quality notifications. The myriad of applications include tracking of national food supply, counterfeit and gray market prevention (pharmaceuticals, jewelry, high-technology, semiconductor chips, and entertainment media, to name a few).

Other examples will be apparent to persons skilled in the art. The scope of this invention should therefore not be determined solely by reference to the above description and tables therein, but instead should be determined inclusive of reference to the appended claims and figures, along with the full scope of equivalents to which such claims are entitled.

1. A method of creating a product composition of a product instance of interest, based on transaction history of said product and where said product is uniquely identifiable by a unique Serial Number, and where transactional data pertinent to said product of interest are accessible via computerized means, said method comprising the steps of:
STEP 1 running a query based on product Serial Number (SN);
STEP 2 selecting all transaction data related to queried SN of STEP 1;
STEP 3 selecting all transaction data with Pointers equal to Pointers in Step 2;
STEP 4 repeating Step 2 and 3 until the top and bottom of the BOM is reached;
STEP 5 a. sorting, grouping and arranging selected transaction data;
b. producing, with the results of step 4a, a product history for queried SN;
c. embellishing product history by selecting data by means of Pointers.

2. A method as in claim 1 further including the steps and sub-steps of:
STEP 6 a. eliminating duplicate and obsolete transaction records;
b. producing a Transactional Bill of Materials (T-BOM™) for queried SN;
c. embellishing transaction records by selecting data by means of Pointers.

3. A method as in claim 1 where Step 4 is eliminated.

4. A method as in claim 2 where Pointers operate so as to collect pertinent data from one or more databases.

5. A method as in claim 1 wherein relevant transaction data is acquired by means of a Unit-Set where Unit-Set is database object that represents every relevant transaction, and hence the associated transaction data, for any given uniquely identifiable product.

6. A method as in claim 3 wherein the query is based on an identifier of other than a specific instance of the product of interest.

7. A method as in claim 6 where the identifier may be a batch or lot number.

8. A computer implemented System for dynamically generating graphical and tabular representation of product composition and historical record of a product instance of a product of interest, where at least one transaction pertinent to the product of interest is used as a data source, and where said transaction pertinent to said product of interest is accessible via computerized means, said System comprising:
means for assigning unique identifier to said product instance of said product of interest;
means for querying databases where said means for querying employs a method comprising the steps of:
STEP 1 running a query based on unique identifier;
STEP 2 selecting all transaction data related to the unique identifier;
STEP 3 selecting all transaction data having Pointers equal to Pointers in STEP 2;
STEP 4 repeating Steps 2 and 3 until the top and bottom of the BOM is reached;
STEP 5 a. sorting, grouping and arranging selected transaction records;
b. producing, with the results of step 5a, a history of the product associated with the unique identifier;
c. embellishing transaction data by selecting data by means of Pointers.

9. A system according to claim 8, wherein said means for requesting data employs a method wherein said further including the Step and sub-steps of:
STEP 6 a. eliminating duplicate and obsolete transaction records;
b. producing a Transactional Bill of Material (T-BOM™) for queried unique identifier;
c. embellishing transaction records by selecting data by means of Pointers.

10. A System as in claim 8, wherein said method does not require Step 4.

11. A System, as in claim 8, wherein said transaction records are organized in a hierarchical form and wherein said hierarchical form may include headers representing class of item of interest, components of item of interest, and unique identifier for an instance of item of interest.

12. A System as in claim 11, wherein said hierarchical form may be rendered into table form, said table form including data fields.

13. A System as in claim 12, wherein said data fields may include the data fields of:
a) unique identifier for item if interest (Serial Number);
b) bill of material (BOM) flag;
c) Pointers where such Pointers are operable to link Unit-Set records with transaction records in multiple databases in one or more database systems;
d) position (indicative of level of composition pertinent to item of interest);
e) calendar date.

14. A System as in claim 8, wherein the System further includes means for automatic acquisition of transactional data pertinent to a unique identifier.

15. A System as in claim 9 wherein the System further includes means for automatically supplementing the transactional data pertinent to a unique identifier.

16. A computer readable medium containing computer implementable instructions sufficient to create a transactional history of an instance of product of interest without reference to a master database, said instructions operable to cause the performance of the steps of:
STEP 1 running a query based on product Serial Number (SN);
STEP 2 selecting all Unit-Set records (where a Unit-Set is a database object that represents every transaction of every serial number) with SN equal to SN in Step 1;
STEP 3 selecting all Unit-Set records with Pointers equal to Pointers in Step 2;
STEP 4 repeating Steps 2 and 3 until the top and bottom of the bill of material depth is reached;
STEP 5 a. sorting, grouping and arranging selected Unit-Set records;
b. producing, with the results of step 5a, a product history for queried SN;
c. embellishing Unit-Set records by selecting data by means of Pointers.

17. A computer readable medium as in claim 16, further operable to perform the Step and sub-steps of:
STEP 6 a. eliminating duplicate and obsolete Unit-Set records;
b. producing a Transactional Bill of Materials (T-BOM™) for queried SN;
c. embellishing Unit-Set records by selecting data by means of Pointers.

18. A computer readable medium as in claim 16, where the Serial Number may be a batch number or lot number.

19. A computer readable medium as in claim 16 further including automatic updating of transaction information from one or more data sources.
